(19) United States
(12) Patent Application Publication
(10) Pub. No.: US 2012/0024234 A1
(43) Pub. Date: Feb. 2, 2012

(54) Animal Cabinet System with Adjustable Feeding Station

(76) Inventors: Grace Scarpa, Newport News, VA (US); Michael Scarpa, Newport News, VA (US)

(21) Appl. No.: 13/195,795

(22) Filed: Aug. 1, 2011

Related U.S. Application Data
(60) Provisional application No. 61/369,325, filed on Jul. 30, 2010.

(51) Int. Cl. A01K 29/00; A47B 96/00

(52) U.S. Cl. 119/51.01

(57) ABSTRACT

In an exemplary embodiment, the feeding station includes a vertically-adjustable shelf or feeding tray having the feeding and water bowls. The shelf or feeding tray is configured to slide in and out from the cabinet to provide easy access to the bowls of the feeding station. The feeding station shelf or tray is configured to be elevated or lowered vertically to adjust to the stature (e.g. height) of the animal. The elevation of the feeding station is configured to be adjusted to one of a plurality of levels (vertically aligned) based on an animal's height. An advantage of the adjustable height is to accommodate different heights as an animal grows from a young animal to an older animal or to accommodate different heights when the animal has a need to change heights (e.g., surgical procedure, etc.). According to further embodiments (not illustrated), the feeding station may include multiple side by side feeding trays that are at different heights to accommodate a plurality of animals, each animal having a different height that is compatible with one of the feeding stations.

### COPENDING APPLICATION

This application claims priority benefit of U.S. Provisional Application Ser. No. 61/369,325, titled “Animal Cabinet System with Adjustable Feeding Station,” filed Jul. 30, 2010, having the same inventors of the instant patent application and which is incorporated herein by reference as if set forth in full below. Applicants intend to file this patent application with Form 421 Certification and Request for Participation in the Extended Missing Parts Program.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

I. Field

The invention relates to furniture, more particularly, a cabinet having an integrated feeding tray for animals.

II. Background

Animal owners find it difficult to organize and store all or most of the animal's personal items, food, health records, toys, etc. in an efficient manner. Instead, for a pet, the pet's toys, leashes, clothes are placed or stored in a variety locations throughout the home. The pet owner typically wastes time finding a particular toy or heath records, when needed, because of the lack of a centralized storage location. In many cases, when a particular item is not found, the owner would re-purchase the product. Thus, the owner may have unnecessarily purchased leashes, collars, or other animal items.

It is well known for animals or pets to feed and drink water from bowls placed on the floor. However, for larger breed dogs or animals, the food consumed may not be optimally digested when consumed from bowls located on ground level.

The present invention provides one or more cabinet units to store a plurality, if not all, canine or animal supplies for one or more animals. The supplies may include food, toys, treats, animal clothes, medicines, grooming supplies, leashes, collars, animal's health records, etc. The one or more cabinet units also include an adjustable feeding, watering or a combination of feeding and watering section configured to be pulled out or slid out from a cabinet unit and elevated to the animal's height. The adjustment of the feeding stations may improve an animal's posture while assisting in proper digestion (e.g., potentially reducing bloating). Moreover, the elevated feeding station may minimize strain on joints and muscles of the animal, as well as the animal's feeder or owner.

### SUMMARY

The aforementioned problems, and other problems, are reduced, according to exemplary embodiments, by an animal cabinet system described herein.

Other systems, methods, and/or products according to embodiments will be or become apparent to one with skill in the art upon review of the following drawings, and further description. It is intended that all such additional systems, methods, and/or products be included within this description, be within the scope of the present invention, and be protected by the accompanying claims.

### BRIEF DESCRIPTION OF THE DRAWINGS

The exemplary embodiments, objects, uses, advantages, and novel features are more clearly understood by reference to the following description taken in connection with the accompanying figures wherein:

FIG. 1 illustrates a front view of the animal cabinet system with doors in a closed state in accordance with exemplary embodiments of the invention;

FIG. 2 illustrates a front view of the animal cabinet system with doors in an open, detached state in accordance with exemplary embodiments of the invention;

FIG. 3 illustrates a front view of the animal cabinet system with the doors removed and to the side in accordance with exemplary embodiments of the present invention;

FIG. 4 illustrates a top view of the feeding station tray assembly showing horizontal extension or extents in accordance with exemplary embodiments of the present invention;

FIG. 5 illustrates a front view of the feeding station tray assembly showing vertical extension or extents in accordance with exemplary embodiments of the present invention;

FIG. 6 illustrates a detailed top plan view of the feeding station tray assembly in accordance with exemplary embodiments of the present invention; and

FIG. 7 illustrates a detailed front elevation view of the feeding station tray assembly in accordance with exemplary embodiments of the present invention;

FIG. 8 illustrates a front elevation view of the animal cabinet system of FIG. 1; and

FIG. 9 illustrates a side elevation view of the animal cabinet system of FIG. 1.

### DESCRIPTION

The word “exemplary” is used herein to mean “serving as an example, instance, or illustration.” Any configuration or design described herein as “exemplary” is not necessarily to be construed as preferred or advantageous over other configurations or designs. Furthermore, use of the words “present invention” is used herein to convey only some of the embodiments of the invention. For example, the words “present invention” would also include alternative embodiments and equivalent systems and components that one of ordinary skill in the art understands. An example is that the materials used for the exemplary embodiments may be made out of man-made materials, natural materials, and combinations thereof. A further example is that the apparatus or components of the apparatus may be manufactured by machine(s), human(s) and combinations thereof.

Some of the embodiments of the invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

In an exemplary embodiment, the present invention is directed to a centralized station to store a plurality of supplies and necessities for at least one animal. The centralized station is an animal cabinet system configured to store one or more of food, toys, treats, animal clothes, medicines, grooming supplies, leashes, colors, animal health records. The animal cabinet system includes a compartment with a feeding station having separate food and water bowls.

In an exemplary embodiment, the feeding station includes a vertically-adjustable shelf or feeding tray having the feeding and water bowls. The shelf or feeding tray is configured to slide in and out from the cabinet to provide easy access to the bowls of the feeding station. The feeding station shelf or tray is configured to be elevated or lowered vertically to adjust to the stature (e.g. height) of the animal. The elevation of the feeding station is configured to be adjusted to one of a plurality of levels (vertically aligned) based on an animal's height. An advantage of the adjustable height is to accommodate different heights as an animal grows from a young animal to an older animal or to accommodate different heights when the animal has a need to change heights (e.g., surgical procedure, etc.). According to further embodiments (not illustrated), the feeding station may include multiple side by side feeding trays that are at different heights to accommodate a plurality of animals, each animal having a different height that is compatible with one of the feeding stations.

While not wishing to be bound by theory, the ability to raise the feeding station shelf or tray helps improve an animal's posture while assisting in proper digestion (i.e. bloat, etc.) and may further minimize strain on joints and muscles.

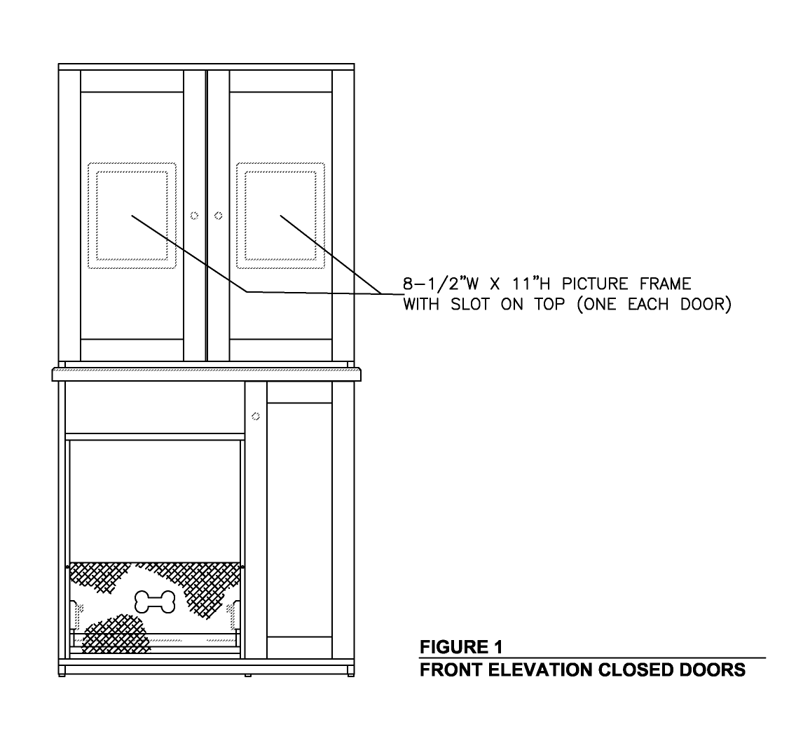

FIGS. 1, 8, and 9 illustrate a front and side views of the animal cabinet system with doors in a closed state in accordance with exemplary embodiments of the invention. In the exemplary embodiment, the animal cabinet system includes a top cabinet section (TCS) and a bottom cabinet section (BCS). The TCS and BCS may be separate cabinet sections. The TCS and BCS may be integrated into a single unit. The TCS and BCS may be configured to be secured to each other.

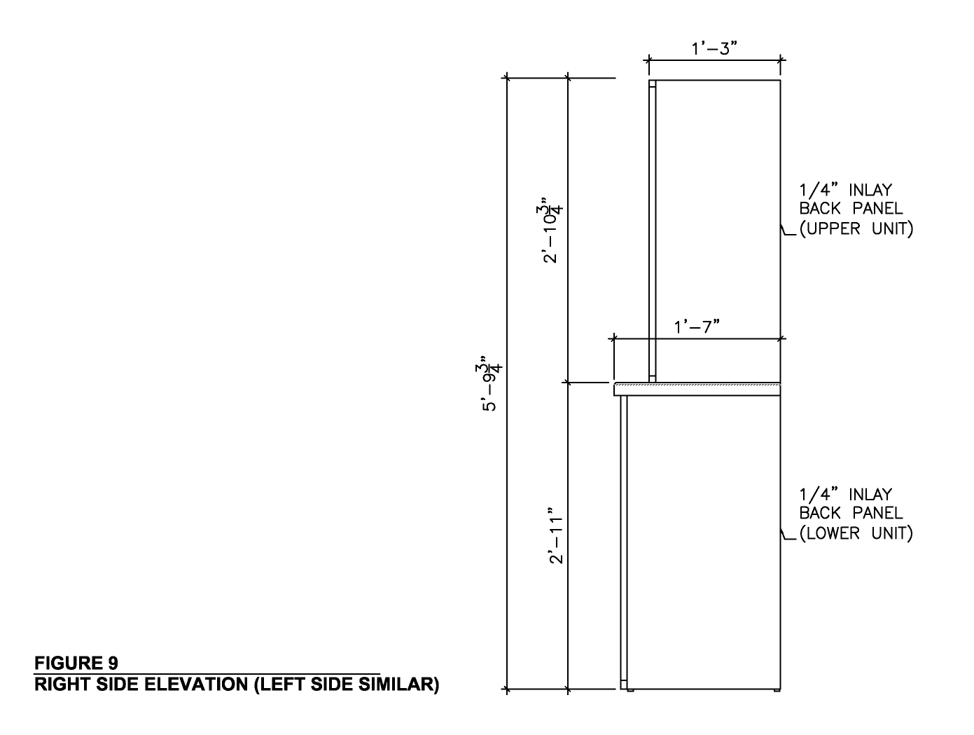

In the exemplary embodiment, the TCS has a narrower width than the BCS as best seen in FIG. 9.

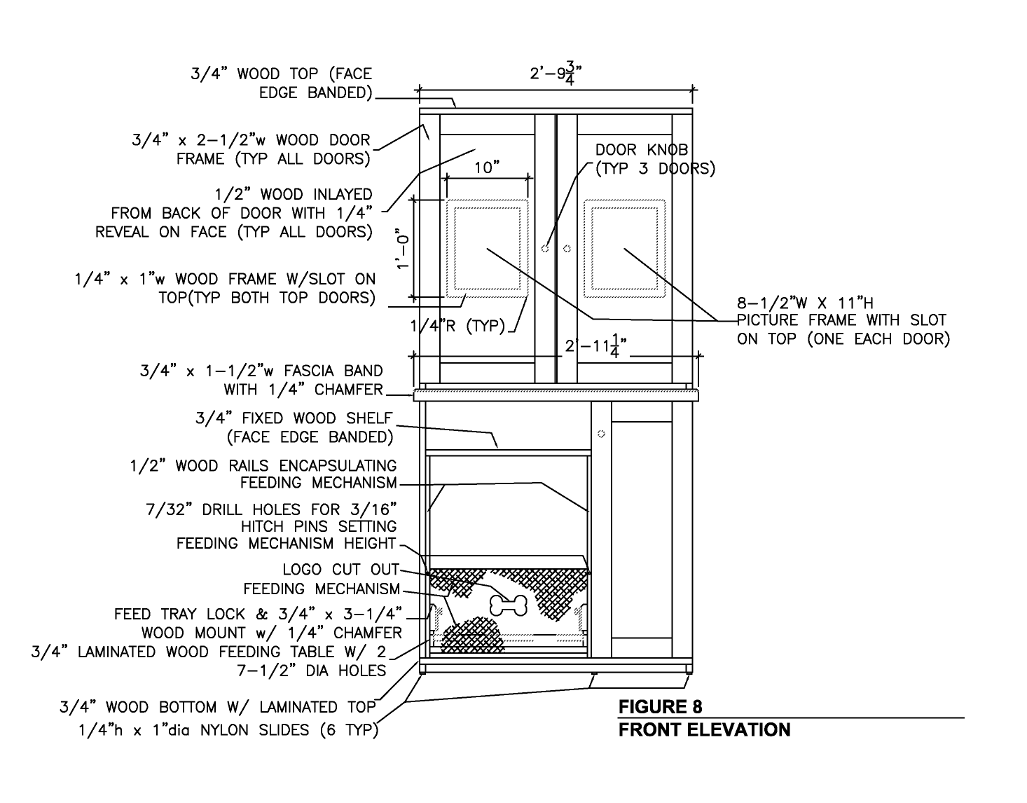

The TCS comprises a cabinet structure having two side walls, a back wall, a top/ceiling wall and a bottom/floor wall. The front of the TCS is closed by doors configured to be opened and closed via a hinge element. The door includes handles. The hinge elements may be hidden within the cabinet or mounted externally. Exterior surfaces of the two side walls may include an integrated picture frame as shown in FIGS. 1 and 8.

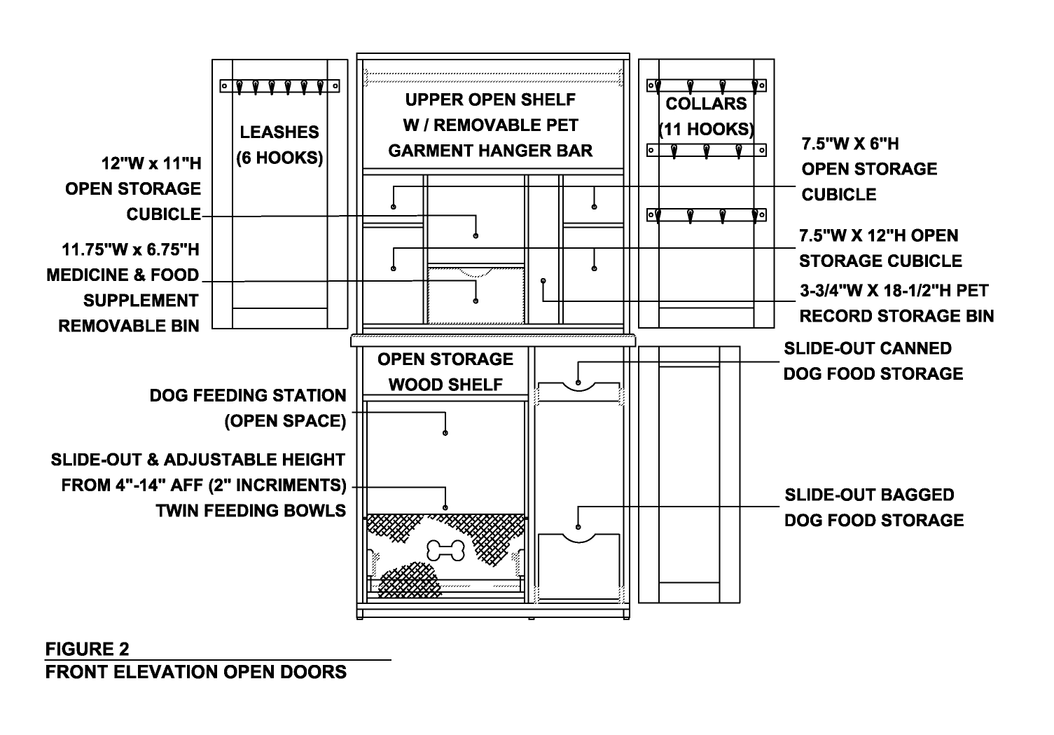

As shown in FIGS. 1, 2, 3 and 8, the animal cabinet system includes a BCS below the TCS. The BCS, like the TCS, comprises a cabinet structure having two side walls, a back wall, a top/ceiling wall and a bottom/floor wall. The BCS includes an open top shelf with an open compartment below that serves as a feeding station. The feeding station is open because the feeding station does not have a door. However, alternate embodiments of the feeding station may include a door to hide the feeding and water bowls, if desired.

In the exemplary embodiment, the feeding station does not have a door and is open for use automatically and continuously (or as desired) by one or more animals. In an exemplary embodiment, the animal cabinet system is for a single animal. Nonetheless, the animal cabinet system may be used for different animals. For example, the feeding station may be used for a dog. However, the storage system of the animal cabinet system may also be used to store food for multiple animals such as a dog, cat, fish, bird, etc.

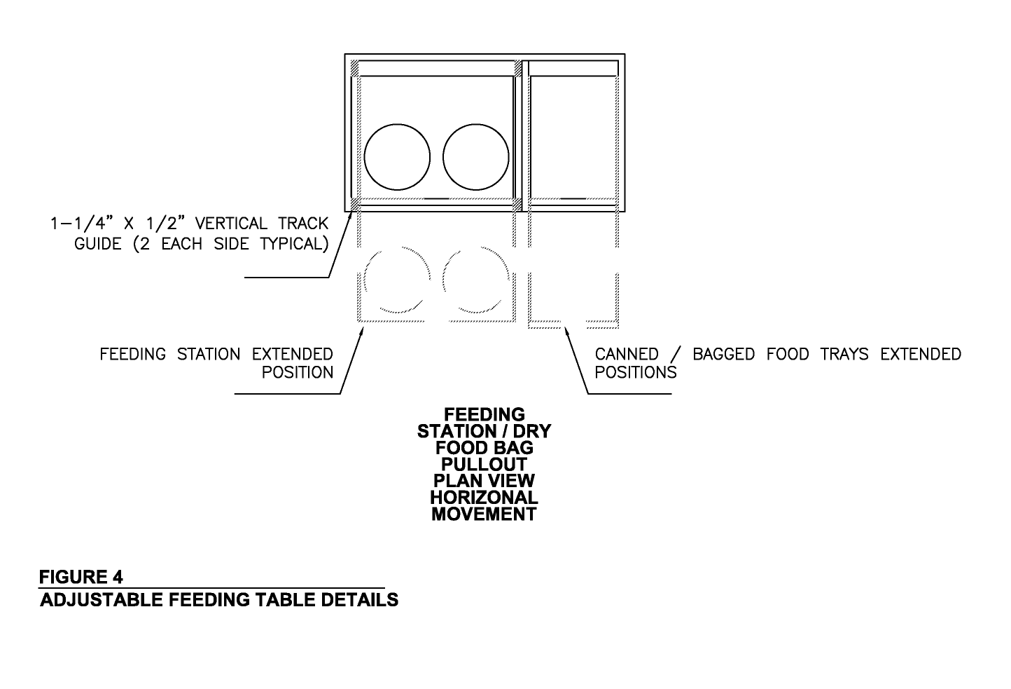

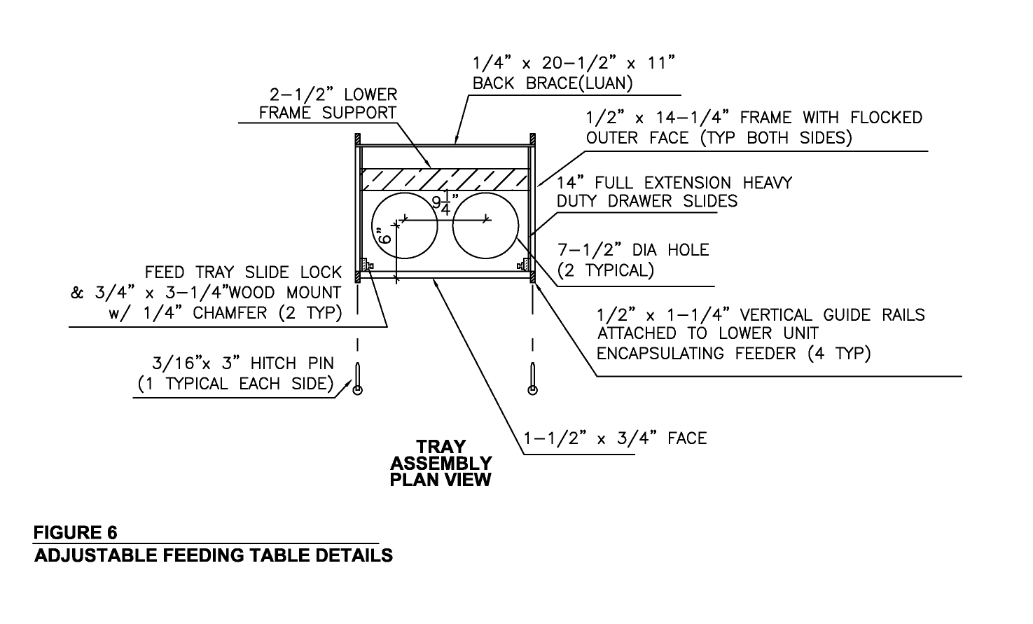

As shown in FIGS. 4 and 6, the animal cabinet system includes a compartment with a feeding station having food and water bowls separate or side-by-side bowls.

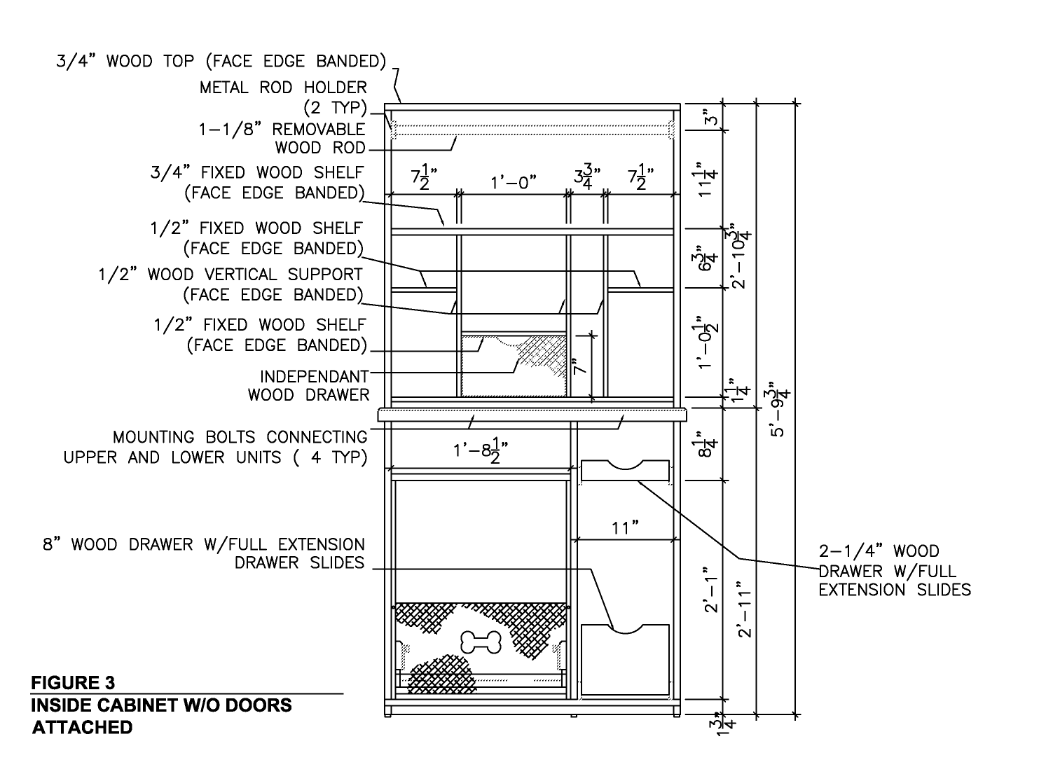

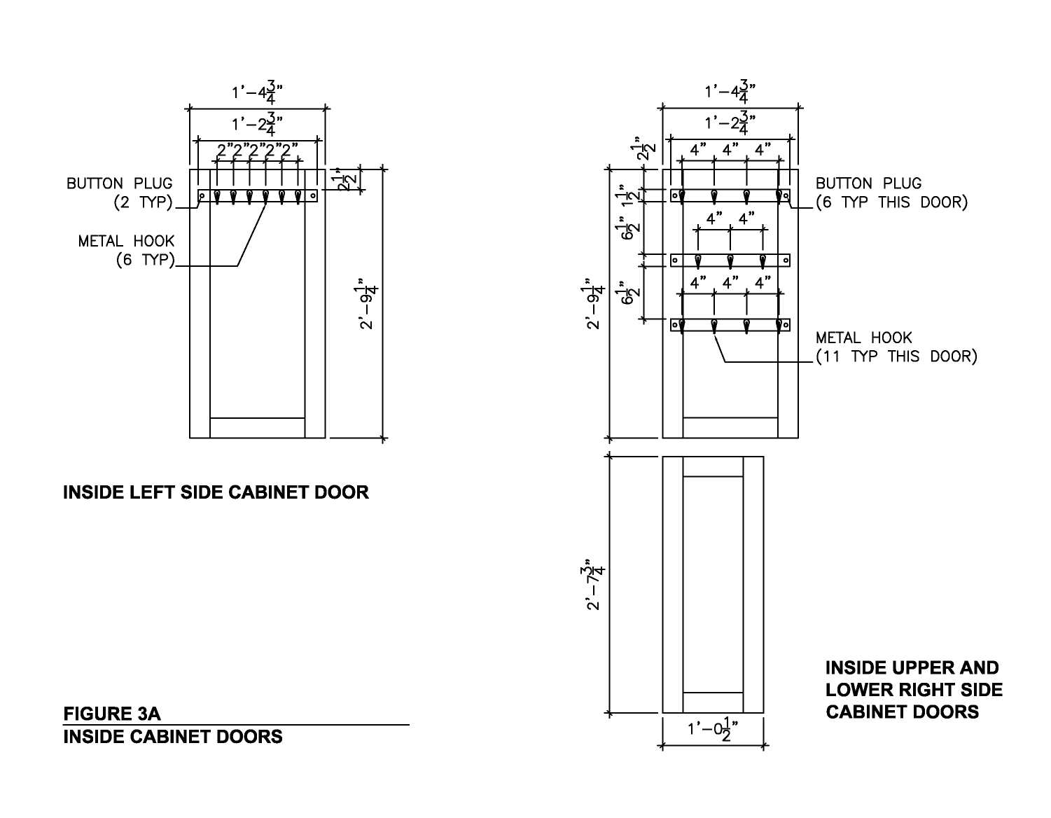

FIG. 3 illustrates a front view of the animal cabinet system with the doors removed and to the side in accordance with exemplary embodiments of the present invention. In the exemplary embodiment, the top portion of the TCS includes a hanger rod to hang an animal's wardrobe or clothes. The hanger rod is optional and may be removed or eliminated. The TCS further includes a storage system having a plurality of discrete or dedicated cabinet organizing elements. The plurality of discrete or dedicated cabinet organizing elements include one or more of storage cubicles, drawers, slots, shelves, etc. to organize, arrange, file, and store a plurality of supplies and necessities for at least one animal in dedicated areas defined by the cubicles, drawers, slots, shelves, etc.

The plurality of discrete or dedicated cabinet organizing elements are configured to store one or more of food, toys, treats, animal clothes, medicines, grooming supplies, leashes, colors, animal health records for one or more animals.

In the exemplary embodiment, the hanger rod extends between sidewalls of the TCS within a top portion of the TCS with the plurality of discrete or dedicated cabinet organizing elements arranged in a bottom portion below such top portion. Nonetheless, the plurality of discrete or dedicated cabinet organizing elements may be arranged in two sections which line the two side walls leaving a center section empty for use to hang the hanger rod and wardrobe.

The TCS may eliminate the hanger rod from the top portion. The top portion would be a larger area with free space to store and organize any variety of items. The TCS is configured to be closed by hinged doors. The doors my include hooks for storing, organizing or attaching leashes, collars, etc. The doors are configured to be closed so that the contents of the TCS are hidden from view.

The storage system includes a combination of open cubicles, sliding drawers, and a clothes hanging bar. Additional, one or more of the interior walls of the storage system may include hooks for handing leashes and other items.

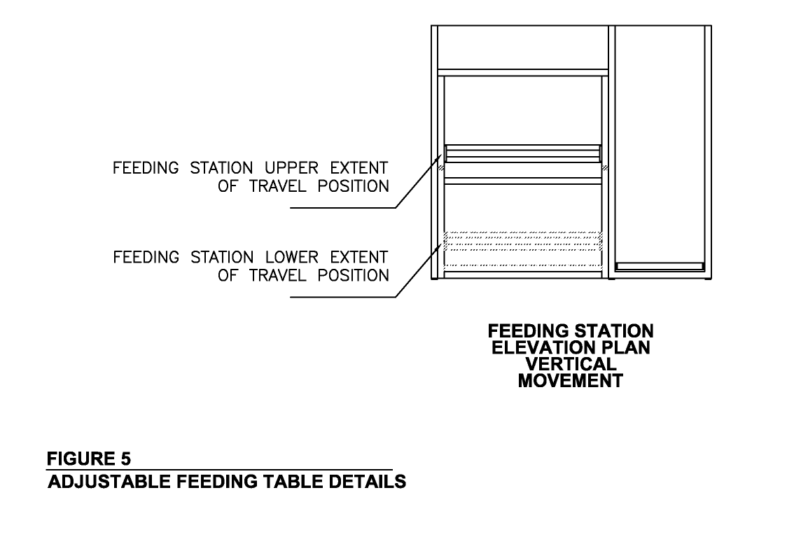

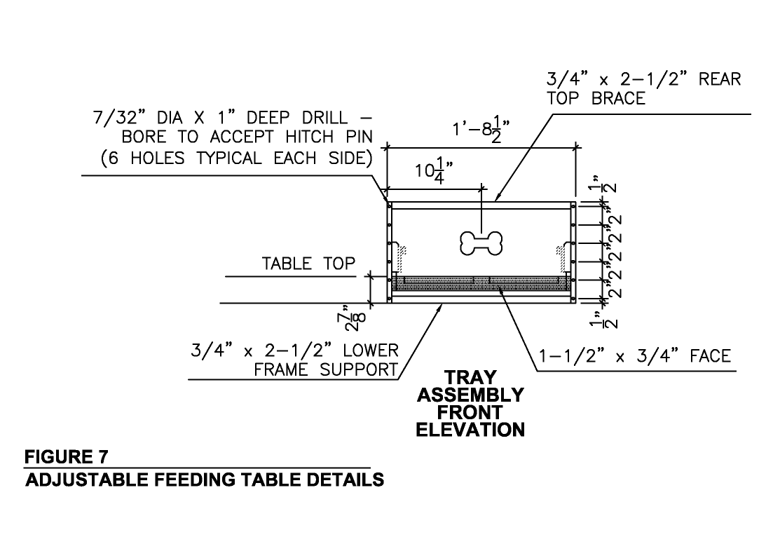

As shown in FIGS. 4 and 6, the feeding station shelf or feeding tray can be pulled out from the main compartment to a locked position and retracted when not in use or between feedings. Additionally, as shown in FIGS. 5 and 7, the elevation of the shelf or feeding tray can be adjusted in two inch increments (or other increments) from approximately four to fourteen inches above floor level based on the pet's size. The range of elevation or adjustment can be varied from 1-10 inches or more than 10 inches and less than one inch.

In the exemplary embodiment shown in FIG. 3, the BCS has a feeding station and a food storage compartment. The food storage compartment has a door that is hingedly attached. The food storage compartment further includes a slide-out drawer or tray such as to place a bag of animal food thereon. In operation, the drawer or tray may be slid out of the food storage compartment so that the food can be dispensed.

In the exemplary embodiment, the food storage compartment has at least one shelf positioned within the food storage compartment. The shelf can be used to place cans of animal. In lieu of a food storage compartment, the compartment may be used for a variety of items while the food for the animal is stored above in the TCS.

As shown in FIGS. 4 and 6, the bowls can both be used for only water, only food, or a combination of food and water. The bowl sizes may vary based on the size of the animal. According to embodiments of the invention, the shelf or feeding tray is customizable in that the size of the bowls can be varied based on the size and type of the animal. For example, for larger breed dogs or animals, the bowls may be larger. The feeding station tray should be made of material or coated with a material that can be cleaned. The floor under the feeding station tray may also be made of material or coated with a material that can be cleaned.

In an embodiment, the BCS includes a hollow cavity with a front wall open (closed on three sides) to install the feeding station with a height adjustment mechanism for elevating the feeding station tray.

The height adjustment mechanism may include slide channels with (or without) wheels, guides, guides or tracks with a locking feature, or other structures that allow for vertical or height elevation or lowering.

FIG. 4 illustrates a top plan view of the bottom cabinet section (BCS) in accordance with exemplary embodiments of the present invention. The BCS includes a feeding station in side by side arrangement with a food storage compartment. The feeding station and slide-out drawer or tray of the food storage compartment are shown in phantom to represent a slide out position.

FIG. 5 illustrates a front plan view of a portion of the bottom cabinet section in accordance with exemplary embodiments of the present invention. The feeding station is represented in a vertically elevated position. The feeding station is also represented in phantom at a lower elevation.

FIG. 6 illustrates a top view of the tray assembly in accordance with exemplary embodiments of the present invention. The tray includes apertures for two bowls in side by side arrangement. The tray is locked into a particular elevation via a hinge pin on each side (left and right sides) of the tray.

FIG. 7 illustrates a front view of the tray assembly in accordance with exemplary embodiments of the present invention. The feeding station includes a frame which is configured to be mounted within the hollow cavity of the BCS. In the exemplary embodiment, the right and left sides of the frame include holes for selectively attaching the hinge pins for adjusting and locking the feeding station tray to a particular vertical elevation.

Nonetheless, other locking mechanism may be used. For example, ovens include a slide channel which has a contour that locks a rack in the oven. Other arrangements are further contemplated. For example, tracks or guides used for draws in cabinets may be used.

Everything for dog is located in consolidated place. Preventing clutter, and searching for items.

In view of the foregoing, the animal cabinet system is configured to consolidate all pet necessities including a feeding station into one centralized location. This, in turn, helps prevent clutter and searching for items.

The animal cabinet system may be made of natural material, man-made materials or a combination of natural and man-made materials. For example, the animal cabinet system may be made of wood, vinyl, plastic, laminates, particle board, engineered woods, etc. The animal cabinet system may include knobs, hinges and other hardware made of natural of natural material, man-made materials or a combination of natural and man-made materials.

The animal cabinet system can be used for dogs. The animal cabinet system may be used for a combination of a dog and fish or birds. As can be appreciated, any combination of animals can use the animal cabinet system.

For a cat, the animal cabinet system may use the food storage compartment in the BCS for a cat litter box. The door to the food storage compartment in the BCS may be removed. Nonetheless, the BCS may be modified to accommodate both the feeding station and the litter box. Nonetheless, the animal cabinet system may be used with cats without the litter box being integrated into the BCS. The litter box for the cat may be placed next to the cabinet system or placed on the shelf or tray of the feeding station. The feeding station shelf or tray may be replaced with a solid shelf with no holes for the bowl placement or with a hole to place a litter box therein. One or more of the shelf in the animal cabinet system may be a slide out shelf for placement of cat food bowls or trays. The food storage compartment can then be used.

The animal cabinet system may support birds or other small animals (e.g., hamsters, mice, snakes, other reptiles, etc.). For example, the TCS may be hollow to support at least one cage or housing for at least one bird or other small animals (e.g., hamsters, mice, snakes, other reptiles, etc.). The BCS would be configured or modified with the storage system to store animal food, health records, toys, etc.

The animal cabinet system is modularly adjustable to modify the cabinet for the particular animal or animals. For example, one or more shelves, walls, drawers are removal and can be replaced with structures to support a particular animal function.

The animal cabinet system may include lighting for lighting the cage or housing area or the storage areas. The animal cabinet system may include holes in the walls (back wall) for ventilation. The animal cabinet system may include access to pass electrical and/or communication wires for connecting any electronic device or sensors, such as, for example, connecting an animal grooming implement, a feeding sensor, a lighting element, etc. to electricity and/or communication lines.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed:

1. A method that includes all patentable subject matter set forth in the application and drawings.

2. A system that includes all patentable subject matter set forth in the application and drawings.
